(19) United States
(12) Patent Application Publication
(10) Pub. No.: US 2019/0057337 A1
(43) Pub. Date: Feb. 21, 2019

(54) METHOD AND SYSTEM FOR PROVIDING TRANSPORTATION SERVICE INFORMATION

(71) Applicant: Beijing Didi Infinity Technology and Development Co., Ltd., Beijing (CN)

(72) Inventor: Qian MU, Beijing (CN)

(73) Assignee: Beijing Didi Infinity Technology and Development Co., Ltd., Beijing (CN)

(21) Appl. No.: 15/855,151

(22) Filed: Dec. 27, 2017

(30) Foreign Application Priority Data
Aug. 16, 2017 (CN) 201710703013.9

(51) Int. Cl. G06Q 10/06; G01C 21/36

(52) U.S. Cl. CPC G06Q 10/06315; G06F 17/30241; G06Q 10/06316; G01C 21/3691

(57) ABSTRACT

Systems and methods for providing transportation service information are disclosed. An exemplary method for providing transportation service information may include obtaining a location of a terminal device and obtaining data representing a heat map for a region surrounding the location of the terminal device. The heat map may represent transportation service requests arranged in a queue waiting to be fulfilled in at least one area within the region. The method may also include identifying, via a processor, at least one supply shortage area within the region. The at least one supply shortage area may be identified at least partially based on the heat map. The method may further include providing, utilizing the terminal device, at least one indication indicating the at least one supply shortage area on the heat map.

### CROSS REFERENCE TO RELATED APPLICATION

The present application is based on and claims the benefits of priority to Chinese Application No. 201710703013.9, filed Aug. 16, 2017, the entire contents of which are incorporated herein by reference.

### TECHNICAL FIELD

The present disclosure relates to providing transportation services, and more particularly, to methods and systems for providing transportation service information.

### BACKGROUND

An online hailing platform (e.g., DiDi™ online) can receive a transportation service request from a passenger and then route the service request to at least one transportation service provider (e.g., a taxi driver, a private car owner, or the like). The service request can be answered by a service provider, or assigned to a service provider if no one picks up the service request within a predetermined period.

When an online hailing platform receives a large number of transportation service requests within a given area, the online hailing platform may place the transportation service requests in a queue so that service vehicles can be assigned to serve the transportation service requests in the queue according to a predetermined regulation. Such areas may be referred to as high demand areas, and in certain situations, drivers of service vehicles located outside of high demand areas may be notified of the locations of the high demand areas so that they can choose to drive to one of such areas to provide services.

It is noted, however, that notifying drivers of the locations of high demand areas may be misleading. For example, while there may be a high demand for transportation services in a particular area, the number of service vehicles available in the area may be high as well. Therefore, it may not be worthwhile for drivers located outside of the area to drive to the area. Embodiments of the present disclosure provide methods and systems that address the aforementioned shortcomings.

### SUMMARY

Embodiments of the disclosure provide a computer-implemented method for providing transportation service. The method may include obtaining a location of a terminal device and obtaining data representing a heat map for a region surrounding the location of the terminal device. The heat map may represent transportation service requests arranged in a queue waiting to be fulfilled in at least one area within the region. The method may also include identifying, via a processor, at least one supply shortage area within the region. The at least one supply shortage area may be identified at least partially based on the heat map. The method may further include providing, utilizing the terminal device, at least one indication indicating the at least one supply shortage area on the heat map.

Embodiments of the disclosure further disclose a device for providing transportation service. The device may include a communication interface, at least one memory, and at least one processor coupled to the communication interface and the at least one memory. The communication interface may be configured to obtain a location of a terminal device and obtain data representing a heat map for a region surrounding the location of the terminal device. The heat map may represent transportation service requests arranged in a queue waiting to be fulfilled in at least one area within the region. The at least one processor may be configured to identify at least one supply shortage area within the region. The at least one supply shortage area may be identified at least partially based on the heat map. The at least one processor may also be configured to provide at least one indication indicating the at least one supply shortage area on the heat map.

Embodiments of the disclosure further disclose a non-transitory computer-readable medium. The non-transitory computer-readable medium may store a set of instructions, when executed by at least one processor of an electronic device, cause the electronic device to perform a method for providing transport service. The method may include obtaining a location of a terminal device and obtaining data representing a heat map for a region surrounding the location of the terminal device. The heat map may represent transportation service requests arranged in a queue waiting to be fulfilled in at least one area within the region. The method may also include identifying at least one supply shortage area within the region. The at least one supply shortage area may be identified at least partially based on the heat map. The method may further include providing, utilizing the terminal device, at least one indication indicating the at least one supply shortage area on the heat map.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for providing transportation service information, according to embodiments of the disclosure.

FIG. 2 illustrates passengers and vehicles within an exemplary area, according to embodiments of the disclosure.

FIG. 3 illustrates a block diagram of an exemplary terminal device for providing transportation service information, according to embodiments of the disclosure.

FIG. 4A illustrates an exemplary user interface displayed on a terminal device, according to embodiments of the disclosure.

FIG. 4B illustrates another exemplary user interface displayed on a terminal device, according to embodiments of the disclosure.

FIG. 4C illustrates yet another exemplary user interface displayed on a terminal device, according to embodiments of the disclosure.

FIG. 5 illustrates a flowchart of an exemplary method for providing transportation service information, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for providing transportation service information. In some embodiments, the system may be configured to obtain the location of a terminal device (e.g., a mobile phone used by a driver of a service vehicle, a navigation device onboard the service vehicle, or the like). The system may also be configured to obtain data representing a heat map for a region surrounding the location of the terminal device. The heat map may represent transportation service requests arranged in one or more queues waiting to be fulfilled in the region. The system may analyze the heat map to identify one or more supply shortage areas in the region. The system may provide an indication of the one or more supply shortage areas to a user of the terminal device (e.g., the driver of the service vehicle). The indication may indicate to the user locations of one or more supply shortage areas on the heat map. In some embodiments, the indication may include a ranking of the supply shortage areas (e.g., ranked based on the number of transportation service requests arranged in a queue waiting to be fulfilled associated with the respective supply shortage areas). In some embodiments, one of the supply shortage areas may be selected (e.g., automatically or manually) as a destination, and the system may help the user navigate to the destination.

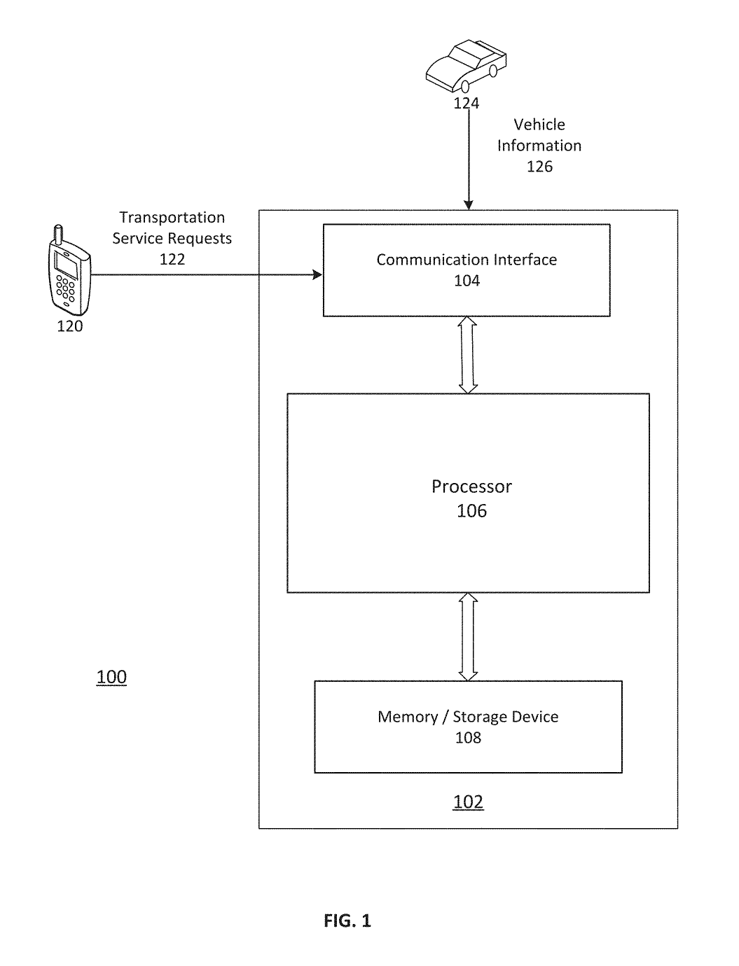

FIG. 1 illustrates a schematic diagram of an exemplary system 100 for providing transportation service information, according to some embodiments of the disclosure.

System 100 may include a transportation service management server 102 (also referred to as server 102 for simplicity). Server 102 can be a general-purpose server or a proprietary device specially designed for providing transportation service. It is contemplated that, server 102 can be a stand-alone system (e.g., a server) or one or more integrated component of a stand-alone system. Because processing transportation service may require significant computation resources, in some embodiments, server 102 may be preferably implemented as a stand-alone system. In some embodiments, server 102 may include sub-systems, some of which may be remote.

In some embodiments, as shown in FIG. 1, server 102 may include a communication interface 104, a processor 106, and a memory/storage device 108. Processor 106 may include one or more hardware units (e.g., portions of an integrated circuit) designed for use with other components or to execute a part of a program. The program may be stored on a computer-readable medium, and when executed by processor 106, it may perform one or more functions. Although FIG. 1 shows communication interface 104, processor 106, and memory/storage device 108 all within one server 102, it is contemplated that these components may be distributed among multiple devices located near to or remotely with each other. In some embodiments, server 102 may be implemented in the cloud, or on a stand-alone computer/server.

Communication interface 104 can be an integrated services digital network (ISDN) card, cable modem, satellite modem, or a modem to provide a data communication connection. As another example, communication interface 104 can be a local area network (LAN) card to provide a data communication connection to a compatible LAN. Wireless links can also be implemented by communication interface 104. In such an implementation, communication interface 104 can send and receive electrical, electromagnetic or optical signals that carry digital data streams representing various types of information via a network. The network can typically include a cellular communication network, a Wireless Local Area Network (WLAN), a Wide Area Network (WAN), or the like.

Communication interface 104 may be configured to receive transportation service requests 122 from one or more passenger terminals 120. A passenger terminal 120 may include any suitable terminal device that can interact with a passenger, e.g., a smart phone, a tablet, a wearable device, a computer, or the like. Transportation service request 122 may include a current location of the passenger, an origin and a destination of the requested transportation service, a request time, or the like. Generally, the origin of the requested transportation service can be the same as or substantially close to a location of the passenger terminal 120. However, it is contemplated that, the origin of the requested transportation can also differ from the location of the passenger terminal 120, even if transportation service request 122 is sent from passenger terminal 120. For example, a user can request a transportation service from a computer for his friend, who is distant from this user. Server 102 can generate an estimated price and send the estimated price back to the passenger terminal for displaying to the passenger.

Communication interface 104 may also be configured to receive vehicle information 126 from one or more service vehicles 124. Service vehicles 124 may include taxi cars or private cars enrolled with the online hailing platform. Service vehicles 124 may also include autonomous vehicles. In some embodiments, service vehicles 124 may be associated with terminal devices such as navigation devices onboard the vehicles 124 or mobile devices used by their drivers (e.g., smart phones, tablets, wearable devices, computers, or the like). These terminal devices may communicate with server 102 and provide vehicle information 126 to server 102 via communication interface 104. Vehicle information 126 provided in this manner may include locations, capacities, current driving directions, vehicle makers and models, as well as other features or characteristics associated with service vehicles 124.

In some embodiments, if server 102 receives a large number of transportation service requests within a given area, server 102 may place the transportation service requests in one or more service queues so that service vehicles can be assigned to serve the transportation service requests placed in the one or more service queues according to a predetermined regulation. In some embodiments, server 102 may queue transportation service requests in a given area when the number of transportation service requests in the area exceeds the capacity provided by service vehicles in the area by a predetermined value.

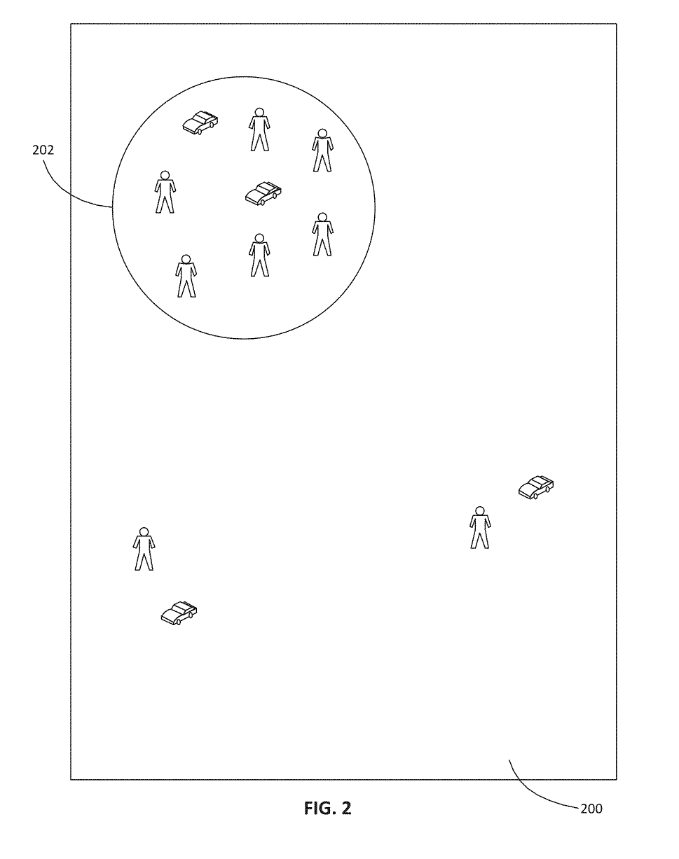

FIG. 2 illustrates an exemplary area 202 within a region 200 (e.g., a city or a portion of the city) where the number of transportation service requests received in the area exceeds the capacity provided by service vehicles in the area. Server 102 may determine the number of service vehicles available to fulfill the transportation service requests in area 202. If the difference between the number of transportation service requests received in area 202 and the number of service vehicles available in area 200 is greater than a threshold, server 102 may place the transportation service requests in area 202 in a queue. In some embodiments, the queue may include all transportation service requests received in area 202. In some embodiments, the queue may include the number of transportation service requests that exceeds the number of service vehicles available in area 202. In some embodiments, the queue may include the number of transportation service requests that exceeds the number of service vehicles available in area 202 by a predetermine number (e.g., the threshold).

It is to be understood that while area 202 depicted in FIG. 2 is a circular area, such a depiction is merely exemplary and is not meant to be limiting. It is contemplated that area 202 may contain other shapes (e.g., rectangular, hexagonal, or the like). It is also contemplated that area 202 may contain an area having a shape and a size dynamically determined without departing from the spirit and scope of the present disclosure. It is further contemplated that the size of the queue formed for area 202 may represent the difference between the number of transportation service requests received in area 202 and the number of service vehicles available in area 202. This information may be utilized to help drivers of service vehicles to locate supply shortage areas so that they can choose to drive to one of such areas to provide services.

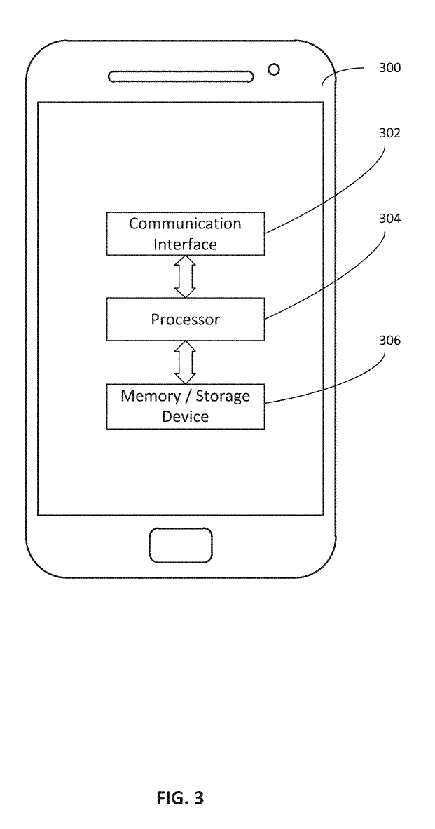

FIG. 3 is a block diagram depicting an exemplary terminal device 300 associated with a service vehicle 124. Terminal device 300 may include a communication interface 302, a processor 304, and a memory/storage device 306. Communication interface 302 may be configured in a manner similar to communication interface 104. Communication interface 302 may facilitate communications between terminal device 300 and server 102. Processor 304 may include one or more hardware units (e.g., portions of an integrated circuit) designed for use with other components or to execute at least part of a program. The program may be stored on a computer-readable medium (e.g., memory/storage device 306), and when executed by processor 304, it may perform one or more functions.

For instance, in some embodiments, processor 304 may be configured to obtain the location of terminal device 300 and identify a region surrounding the location of terminal device 300. The region may include areas within a predetermined distance (e.g., 4 kilometers) away from the location of terminal device 300. Alternatively, the region may include the city a portion of the city) where terminal device 300 is located. It is to be understood that the region may be identified in various other manners without departing from the spirit and scope of the present disclosure.

Processor 304 may also be configured to obtain data representing a heat map for the identified region. The heat map may represent transportation service requests arranged in one or more queues waiting to be fulfilled in one or more areas within the region. In some embodiments, processor 304 may obtain the heat map from server 102.

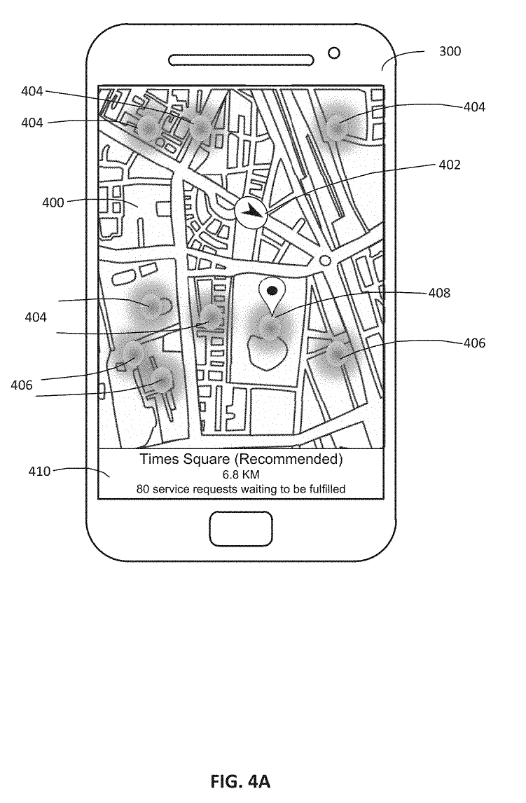

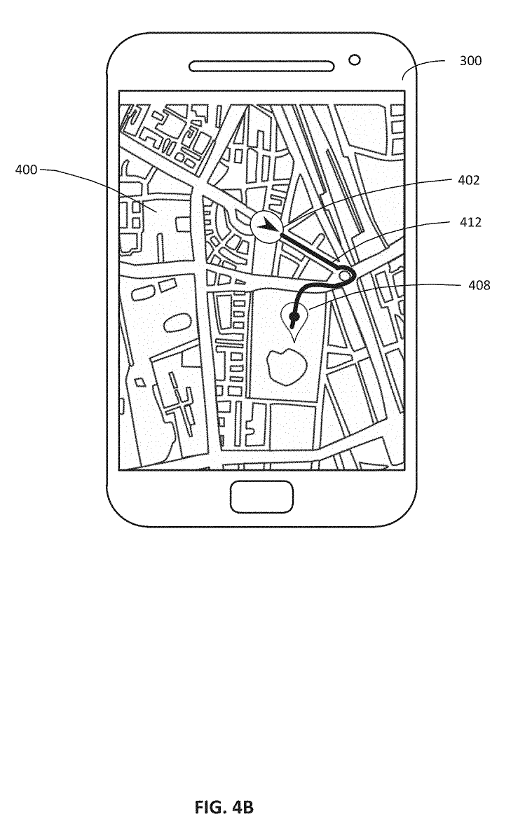

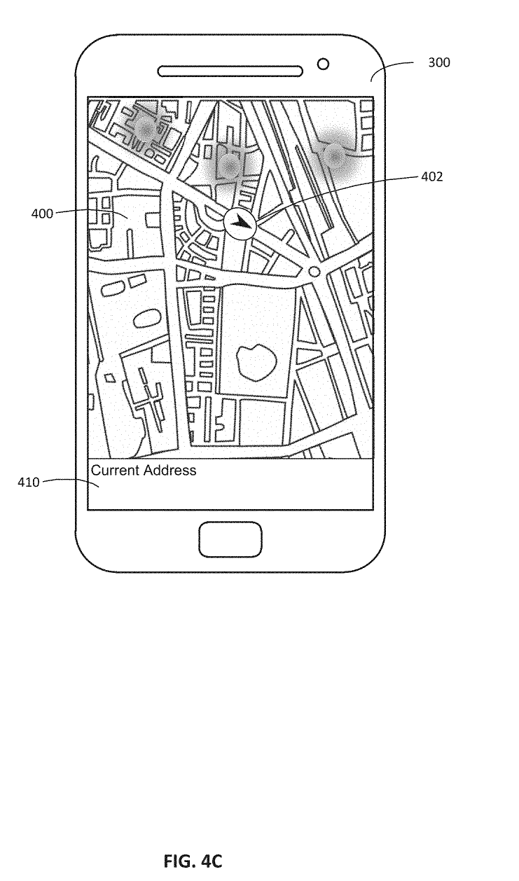

For instance, as illustrated in FIG. 4A, server 102 may identify one or more areas (e.g., 404, 406, and 408) within a region 400 (identified by terminal device 300) in which transportation service request queues have been formed. Server 102 may also identify the locations of such areas (e.g., 404, 406, and 408) on a map representing region 400. Server 102 may further generate one or more indicators configured to indicate the size of the queues corresponding to these areas such as 404, 406, and 408. It is to be understood that server 102 may indicate the size of the queues using text, color, brightness, intensity, or the like. The resulting map, as illustrated in FIG. 4A, may be referred to as a heat map, which may represent transportation service requests arranged in one or more queues waiting to be fulfilled in one or more areas (e.g., 404, 406, and 408) within region 400.

Server 102 may provide data representing the heat map to processor 304. Processor 304 may analyze the heat map to identify one or more supply shortage areas within region 400. In some embodiments, not all areas (e.g., 404, 406, and 408 in which transportation service request queues have been formed) are automatically considered to be supply shortage areas. In some embodiments, for example, processor 304 may only identify areas that have transportation service request queues of a certain size (e.g., above a threshold size) as supply shortage areas, e.g., 406 and 408. In some embodiments, processor 304 may only identify areas (e.g., 406 and 408) that have transportation service request queues formed within a certain time period (e.g., within the last 30 minutes) as supply shortage areas. It is to be understood that processor 304 may utilize other criteria to help identify supply shortage areas without departing from the spirit and scope of the present disclosure.

In some embodiments, processor 304 may rank supply shortage areas (e.g., 406 and 408) based on various criteria. For example, processor 304 may rank supply shortage areas based on the sizes of their corresponding transportation service request queues. Processor 304 may indicate the ranking information to the user of terminal device 300. For example, processor 304 may provide an indicator 410 that indicates the identity of a first ranked (e.g., highest ranked) supply shortage area 408. The indicator 410 may indicate, for example, the address of supply shortage area 408, the distance from the current position 402 of terminal device 300 to supply shortage area 408, as well as the size of the transportation service request queue of the supply shortage area 408 (representing the number of transportation service requests arranged in a queue waiting to be fulfilled within supply shortage area 408). Alternatively or additionally, processor 304 may indicate the ranking information using different colors. For example, processor 304 may assign red to the highest ranked supply shortage area, green to the lowest ranked supply shortage area, and a range of colors to the supply shortage areas in between. It is to be understood that processor 304 may utilize other types of visual representations to indicate ranking information without departing from the spirit and scope of the present disclosure.

In some embodiments, processor 304 may be configured to automatically select one of the supply shortage areas as a recommended destination. Processor 304 may, for example, select the highest ranked supply shortage area (e.g., 408) as the recommended destination. Alternatively, processor 304 may select the nearest supply shortage area as the recommended destination. It is to be understood that the user of terminal device 300 may program or customize the selection scheme utilized by processor 304. It is also to be understood that the user of terminal device 300 may confirm the recommended destination, or manually select another supply shortage area as the destination and initiate a navigation command. Once the destination is selected (e.g., either manually or automatically), processor 304 may indicate the destination address, determine a route to the destination, and provide the route to the user using terminal device 300. FIG. 4B illustrates such an exemplary route 412 to the selected destination.

It is contemplated that there may be situations where processor 304 may analyze the heat map obtained for region 400 and determine that there is no supply shortage area within region 400. This may be because there is no area in region 400 in which a transportation service request queue has been formed. Alternatively, this may be because none of the areas that have transportation service request queues has a queue size above the threshold size for it to be recognized as a supply shortage area. In such cases, processor 304 may simply provide the heat map obtained (e.g., from server 102) to the user, as illustrated in FIG. 4C

It is to be understood that the user interfaces depicted in FIGS. 4A-4C are merely exemplary and are not meant to be limiting. It is contemplated that other types of user interfaces may be utilized to provide other types of information to the user without departing from the spirit and scope of the present disclosure.

It is to be understood that while the description above referenced processor 304 as the processor configured to identify the region surrounding the location of terminal device 300 and the processor configured to identify one or more supply shortage areas within the region, such a configuration is merely exemplary and is not meant to be limiting. It is contemplated that because processor 106 of server 102 also have access to service vehicle information, processor 106 may be configured to identify the region surrounding the service vehicle and identify one or more supply shortage areas within the region. It is therefore contemplated that processor 304. and processor 106 may jointly or independently carry out the functions described above without departing from the spirit and scope of the present disclosure.

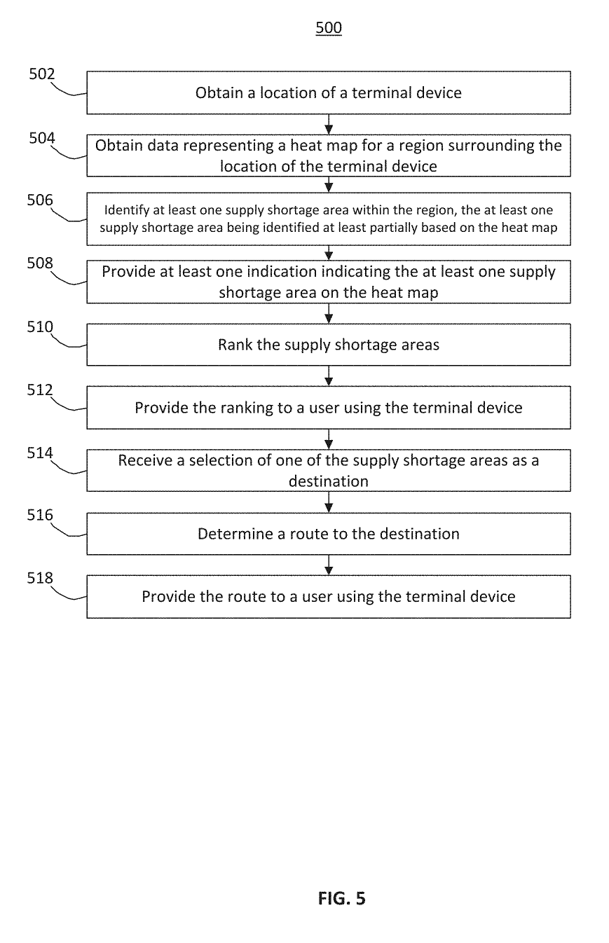

Another aspect of the disclosure is directed to a method for providing transportation service information. FIG. 5 is a flowchart illustrating an exemplary method 500 for providing transportation service information consistent with disclosed embodiments. Method 500 may be implemented by server 102 and/or terminal device 300, each including at least one processor. Method 500 may include steps 502-518 as described below.

In step 502, method 500 may include obtaining a location of a terminal device. In step 504, method 500 may include obtaining data representing a heat map for a region surrounding the location of the terminal device. The region may include areas within a predetermined distance away from the location of the terminal device. Alternatively, the region may include the city (or a portion of the city) where the terminal device is located. It is to be understood that the region may be identified in various other manners without departing from the spirit and scope of the present disclosure.

The heat map may represent transportation service requests arranged in one or more queues waiting to be fulfilled in one or more areas within the region. In step 506, method 500 may include processing the heat map to identify at least one supply shortage area within the region. For example, method 500 may identify areas that have transportation service request queues of a certain size (e.g., above a threshold size) as supply shortage areas. In another example, method 500 may identify areas that have transportation service request queues formed within a certain time period as supply shortage areas. The size of a transportation service request queue may represent the difference between the number of transportation service requests received in an area and the number of service vehicles available in that area. It is to be understood that method 500 may utilize other criteria to help identify supply shortage areas without departing from the spirit and scope of the present disclosure.

In step 508, method 500 may include providing indications of the one or more supply shortage areas to a user of the terminal device. In some embodiments, method 500 may include marking the locations of the supply shortage areas on a map displayed by the terminal device. Alternatively, method 500 may include indicating the locations of the supply shortage areas on the heat map. In this manner, if a first supply shortage area has more transportation service requests arranged in a queue waiting to be fulfilled than those of a second supply shortage area, method 500 may include indicating the first supply shortage area with more emphasis than the second supply shortage area (e.g., using a different color, brightness, intensity, size, or the like).

In step 510, method 500 may include ranking the supply shortage areas based on various criteria. For example, method 500 may include ranking the supply shortage areas based on the sizes of their corresponding transportation service request queues (e.g., representing the numbers of transportation service requests arranged in the queues waiting to be fulfilled in each respective supply shortage area). Method 500 may then provide the ranking information to the user of the terminal device in step 512. In some embodiments, method 500 may provide the ranking information in a text format. Alternatively or additionally, method 500 may indicate the ranking information using different colors. It is to be understood that method 500 may utilize other types of visual representations to indicate ranking information without departing from the spirit and scope of the present disclosure.

In some embodiments, method 500 may include receiving, in step 514, a selection of one of the supply shortage areas as a destination. The destination may be selected manually (e.g., by the user) or automatically (e.g., based on certain predetermined selection scheme). Once the destination is selected (e.g., either manually or automatically), method 500 may include determining a route to the destination (in step 516) and providing the route to the user using terminal device (in step 518), as previously described.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may include a storage device and/or a memory device having the computer instructions stored thereon, as disclosed. In some embodiments, the computer-readable medium may include a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
obtaining a location of a terminal device;
obtaining data representing a heat map for a region surrounding the location of the terminal device, the heat map representing transportation service requests arranged in a queue waiting to be fulfilled in at least one area within the region;
identifying, via a processor, at least one supply shortage area within the region, the at least one supply shortage area being identified at least partially based on the heat map; and
providing, utilizing the terminal device, at least one indication indicating the at least one supply shortage area on the heat map.

2. The method of claim 1, further comprising:
obtaining the data representing the heat map from a transportation service management server.

3. The method of claim 1, wherein the region includes areas within a predetermined distance away from the location of the terminal device.

4. The method of claim 1, wherein the data representing the heat map comprises data representing a difference between a number of service vehicles in each area in the region and a number of transportation service requests in the respective area.

5. The method of claim 1, wherein the data representing the heat map comprises data representing a difference between a number of service vehicles in each area in the region within a time period and a number of transportation service requests in the respective area within the time period.

6. The method of claim 1, wherein the at least one supply shortage area comprises a plurality of supply shortage areas, and wherein the method further comprises:
ranking, via the processor, the plurality of supply shortage areas based on a number of transportation service requests arranged in the queue waiting to be fulfilled in each respective supply shortage area; and
providing the ranking to a user utilizing the terminal device.

7. The method of claim 1, further comprising:
receiving a selection of one of the at least one supply shortage area as a destination;
determining a route to the destination; and
providing the route to a user utilizing the terminal device.

8. The method of claim 1, further comprising:
automatically selecting one of the at least one supply shortage area as a destination;
determining a route to the destination; and
providing the route to a user utilizing the terminal device.

9. The method of claim 1, wherein the at least one indication further indicates a number of transportation service requests arranged in the queue waiting to be fulfilled in the at least one supply shortage area.

10. The method of claim 9, wherein the number of transportation service requests arranged in the queue waiting to be fulfilled in the at least one supply shortage area is indicated in a text format.

11. The method of claim 9, wherein the number of transportation service requests arranged in the queue waiting to be fulfilled in the at least one supply shortage area is indicated using a color.

12. A device for providing transportation service, comprising:
a communication interface configured to:
obtain a location of a terminal device; and
obtain data representing a heat map for a region surrounding the location of the terminal device, the heat map representing transportation service requests arranged in a queue waiting to be fulfilled in at least one area within the region;
at least one memory; and
at least one processor coupled to the communication interface and the at least one memory, the at least one processor configured to:
identify at least one supply shortage area within the region, the at least one supply shortage area being identified at least partially based on the heat map; and
provide at least one indication indicating the at least one supply shortage area on the heat map.

13. The device of claim 12, wherein the communication interface is further configured to:
obtain the data representing the heat map from a transportation service management server.

14. The device of claim 12, wherein the region includes areas within a predetermined distance away from the location of the terminal device.

15. The device of claim 12, wherein the data representing the heat map comprises data representing a difference between a number of service vehicles in each area in the region and a number of transportation service requests in the respective area.

16. The device of claim 12, wherein the data representing the heat map comprises data representing a difference between a number of service vehicles in each area in the region within a time period and a number of transportation service requests in the respective area within the time period.

17. The device of claim 12, wherein the at least one supply shortage area comprises a plurality of supply shortage areas, and wherein the at least one processor is further configured to:
rank the plurality of supply shortage areas based on a number of transportation service requests arranged in the queue waiting to be fulfilled in each respective supply shortage area; and
provide the ranking to a user utilizing the terminal device.

18. The device of claim 12, wherein the at least one processor is further configured to:
identify one of the at least one supply shortage area as a destination;
determine a route to the destination; and
provide the route to a user utilizing the terminal device.

19. The device of claim 12, wherein the at least one indication further indicates a number of transportation service requests arranged in the queue waiting to be fulfilled in the at least one supply shortage area.

20. A non-transitory computer-readable medium that stores a set of instructions, when executed by at least one processor of an electronic device, cause the electronic device to perform a method for providing transport service, the method comprising:
obtaining a location of a terminal device;
obtaining data representing a heat map for a region surrounding the location of the terminal device, the heat map representing transportation service requests arranged in a queue waiting to be fulfilled in at least one area within the region;
identifying at least one supply shortage area within the region, the at least one supply shortage area being identified at least partially based on the heat map; and
providing, utilizing the terminal device, at least one indication indicating the at least one supply shortage area on the heat map.
